(19) United States
(12) Patent Application Publication
(10) Pub. No.: US 2018/0262068 A1
(43) Pub. Date: Sep. 13, 2018

(54) ROTARY ELECTRIC MACHINE

(71) Applicant: TOYOTA JIDOSHA KABUSHIKI KAISHA, Toyota-shi (JP)

(72) Inventor: Naoto KOSHINO, Okazaki-shi (JP)

(73) Assignee: TOYOTA JIDOSHA KABUSHIKI KAISHA, Toyota-shi (JP)

(21) Appl. No.: 15/914,552

(22) Filed: Mar. 7, 2018

(30) Foreign Application Priority Data
Mar. 10, 2017 (JP) 2017-046384

(51) Int. Cl. H02K 1/20; H02K 1/16; H02K 1/18; H02K 3/12; H02K 9/19

(52) U.S. Cl. CPC H02K 1/20; H02K 1/16; H02K 9/19; H02K 3/12; H02K 1/185

(57) ABSTRACT

A rotary electric machine includes: a stator core including an annular yoke, a plurality of teeth, and a plurality of slots; a resin member; an annular cuff support having a plurality of ribs and a plurality of openings; and a coil including an annular coil end. A cylindrical outer-peripheral flange is provided such that the outer-peripheral flange is apart from the coil end, and the outer-peripheral flange is opposed to the coil end, the resin member is provided such that the resin member is apart from the cuff support, and the resin member covers a part of the outer-peripheral flange and the coil end, and the outer-peripheral flange, the coil end, the resin member, and the cuff support define a first gap among the outer-peripheral flange, the coil end, the resin member, and the cuff support.

### INCORPORATION BY REFERENCE

The disclosure of Japanese Patent Application No. 2017-046384 filed on Mar. 10, 2017 including the specification, drawings and abstract is incorporated herein by reference in its entirety.

### BACKGROUND

### 1. Technical Field

The present disclosure relates to a structure of a rotary electric machine, and more particularly relates to a rotary electric machine provided with a structure for cooling a coil end. The rotary electric machine of the present disclosure is provided in a vehicle, for example, as a motor for driving a vehicle.

### 2. Description of Related Art

In a rotary electric machine such as a motor or a motor generator, a loss such as a copper loss, an iron loss, and a mechanical loss occurs along with driving, and heat is generated according to such a loss. When the rotary electric machine reaches an excessively high temperature due to this heat generation, deterioration of components, demagnetization of permanent magnets, and the like are caused. In view of this, the following technique is conventionally proposed. That is, a liquid, e.g., an oil coolant, serving as a refrigerant is jetted to a coil end projecting axially outward relative to a stator core in a stator coil, so as to cool the stator coil.

However, in a cooling method in which the oil coolant is jetted to the stator coil, cooling efficiency is low, so that it is necessary to jet a large quantity of the oil coolant to the coil end. On this account, such a rotary electric machine is proposed that a cover is attached to a coil end so as to cover an outer surface of the coil end, and an oil coolant is caused to flow through a space between the cover and the coil end so as to cool the coil end (e.g., see Japanese Patent Application Publication No. 2010-124658 (JP 2010-124658 A)).

### SUMMARY

However, in the rotary electric machine described in JP 2010-124658 A, the cover is attached to an outer side of the coil end, which causes problems such as an increase in size of a stator and an increase of the number of components.

In view of this, the present disclosure is intended to cool a stator efficiently with a simple configuration.

As example of aspect of the prevent disclosure is a rotary electric machine. The rotary electric machine includes: a stator core including an annular yoke, a plurality of teeth projecting toward an inner peripheral side of the yoke, the teeth defining a plurality of slots between the teeth; an annular cuff support having a plurality of ribs corresponding to the teeth and a plurality of openings corresponding to the slots, the cuff support being placed between the stator core and the resin member; and a coil passing through the slots and the openings, the coil including an annular coil end that is adjacent to an axial end of the stator core, and the coil wound around the teeth and the ribs. The cuff support includes a cylindrical outer peripheral flange having an inside diameter larger than an outside diameter of the coil end and extending in a direction opposite to a center of an axial direction of the stator core. The outer-peripheral flange is provided such that the outer-peripheral flange is apart from the coil end, and the outer-peripheral flange is opposed to the coil end. The resin member is provided such that the resin member is apart from the cuff support, and the resin member covers a part of the outer-peripheral flange and the coil end, and the outer-peripheral flange, the coil end, the resin member, and the cuff support define a first gap among the outer-peripheral flange, the coil end, the resin member, and the cuff support.

In the rotary electric machine of the present disclosure, when a rotating shaft of the rotary electric machine is placed with a posture intersecting with a gravitational direction, the flange may have a first hole through which a refrigerant is introduced into the first gap and a second hole through which the refrigerant is discharged from the first gap, the first hole may be placed on an upper side in the gravitational direction relative to the rotating shaft, and the second hole may be placed on a bottom end of the flange in the gravitational direction.

In the rotary electric machine of the present disclosure, the cuff support may include a cylindrical inner peripheral flange having an outside diameter smaller than an inside diameter of the coil end and extending in a direction opposite to the center of the stator core; the inner-peripheral flange may be provided such that the inner-peripheral flange is apart from the coil end, and the inner-peripheral flange may be opposed to the coil end; the resin member may be provided such that the resin member is apart from the cuff support, and the resin member may cover the inner-peripheral flange and the coil end; and the resin member, the inner peripheral flange, the coil end, and the cuff support may define a second gap among the resin member, the inner peripheral flange, the coil end, and the cuff support.

In the rotary electric machine of the present disclosure, when the rotating shaft of the rotary electric machine may be placed with a posture intersecting with the gravitational direction, the cuff support may have a third hole through the refrigerant is discharged from the second gap toward a rotor, and the third hole may be placed on the upper side in the gravitational direction relative to the rotating shaft.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view of an outer shape of a stator for a rotary electric machine according to an embodiment of the present disclosure;

FIG. 2 is an exploded perspective view illustrating a structure of the stator illustrated in FIG. 1;

FIG. 3 is a perspective view illustrating a cuff support placed in an axial end surface of a stator core illustrated in FIG. 1;

FIG. 4 is a perspective view illustrating the stator in a state where a coil is formed such that conductor segments illustrated in FIG. 1 are bent and welded;

FIG. 5 is a sectional view illustrating a state where resin molding is performed on a coil end of the stator illustrated in FIG. 4;

FIG. 6 is a side view illustrating an arrangement of a refrigerant introduction hole and a refrigerant discharge hole of the rotary electric machine in which the stator illustrated in FIG. 5 is incorporated, and flows of a refrigerant;

FIG. 7 is a perspective view illustrating a slit provided in the cuff support so as to form the refrigerant introduction hole and the refrigerant discharge hole illustrated in FIG. 6;

FIG. 8 is a perspective view illustrating a cuff support of a rotary electric machine of another embodiment of the present disclosure;

FIG. 9 is a perspective view illustrating a stator in a state where a coil is formed such that the cuff support illustrated in FIG. 8 is attached to the stator core illustrated in FIG. 2 and conductor segments are bent and welded;

FIG. 10 is a sectional view illustrating a state where resin molding is performed on a coil end of the stator illustrated in FIG. 9; and

FIG. 11 is a side view illustrating an arrangement of a refrigerant introduction hole, a refrigerant discharge hole, and a rotor refrigerant supply hole of the rotary electric machine in which the stator illustrated in FIG. 10 is incorporated, and flows of a refrigerant.

### DETAILED DESCRIPTION OF EMBODIMENTS

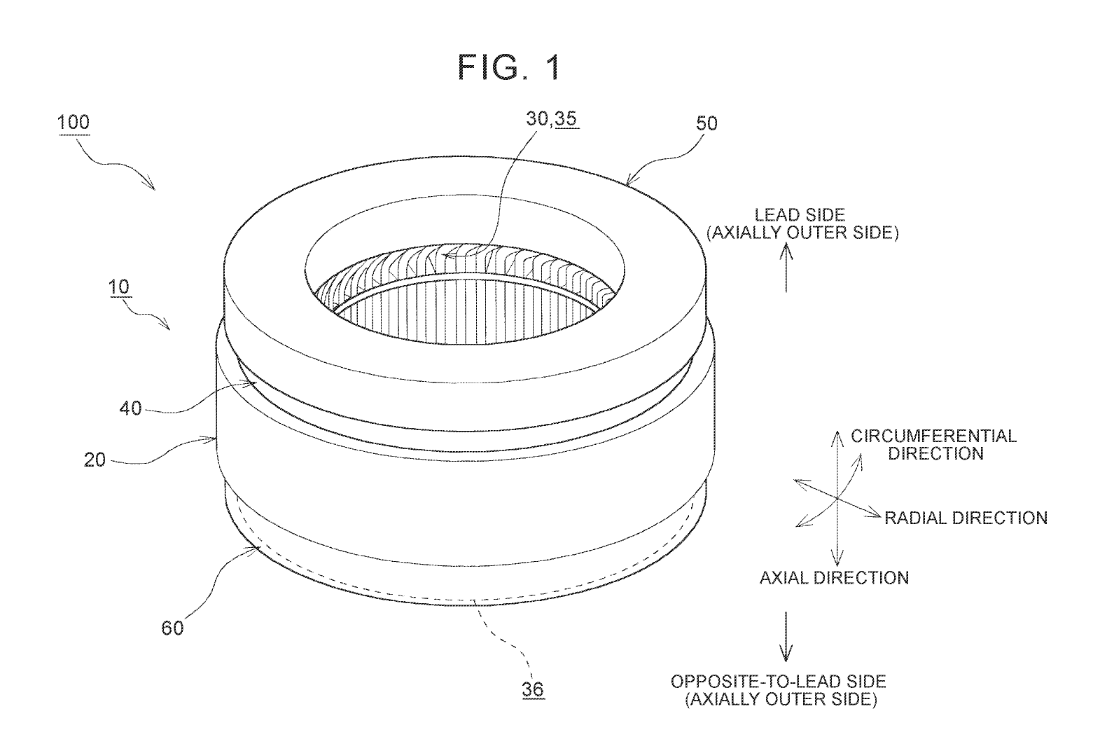

With reference to the drawings, the following describes a rotary electric machine 100 of the present embodiment. As illustrated in FIG. 1, the rotary electric machine 100 of the present embodiment is configured such that a coil end 35 on a lead side of a stator 10 and a cuff support 40 are integrally molded with a resin 50, and a coil end 36 on an opposed-lead side and a cuff support 40 are integrally molded with a resin 60. Note that, since input and output terminals (not shown) of the coil 30 are attached to a coil-end-35 side of the stator 10 illustrated in FIG. 1, the coil-end-35 side of the stator 10 is referred to as the lead side and a coil-end-36 thereof is referred to as the opposite-to-lead side in the following description. A resin 50 and 60 are an example of resin member.

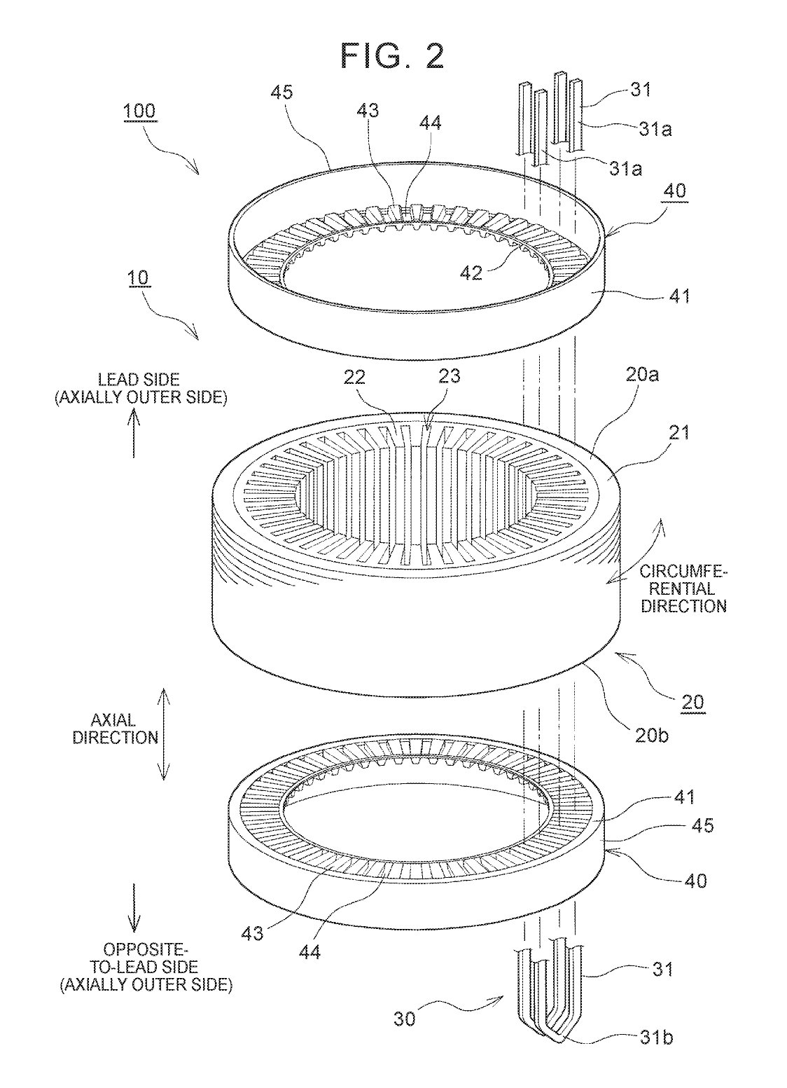

As illustrated in FIG. 2, the stator 10 is constituted by a stator core 20, the cuff supports 40 attached to axial end surfaces 20a, 20b of the stator core 20, and the coil 30 wound around the stator core 20 and the cuff supports 40.

The stator core 20 is configured such that a plurality of electromagnetic steel sheets is laminated. The stator core 20 includes an annular yoke 21 extending along a circumferential direction of the stator 10, and a plurality of teeth 22 projecting toward a radially inner side of the stator 10 from an inner peripheral surface of the yoke 21. The plurality of teeth 22 is placed at regular intervals in the circumferential direction of the stator 10. A slot 23 is formed between the teeth 22 adjacent to each other in the circumferential direction of the stator 10. A plurality of slots 23 is placed at regular intervals in the circumferential direction of the stator. The teeth 22 and the slots 23 extend along an axial direction of the stator 10.

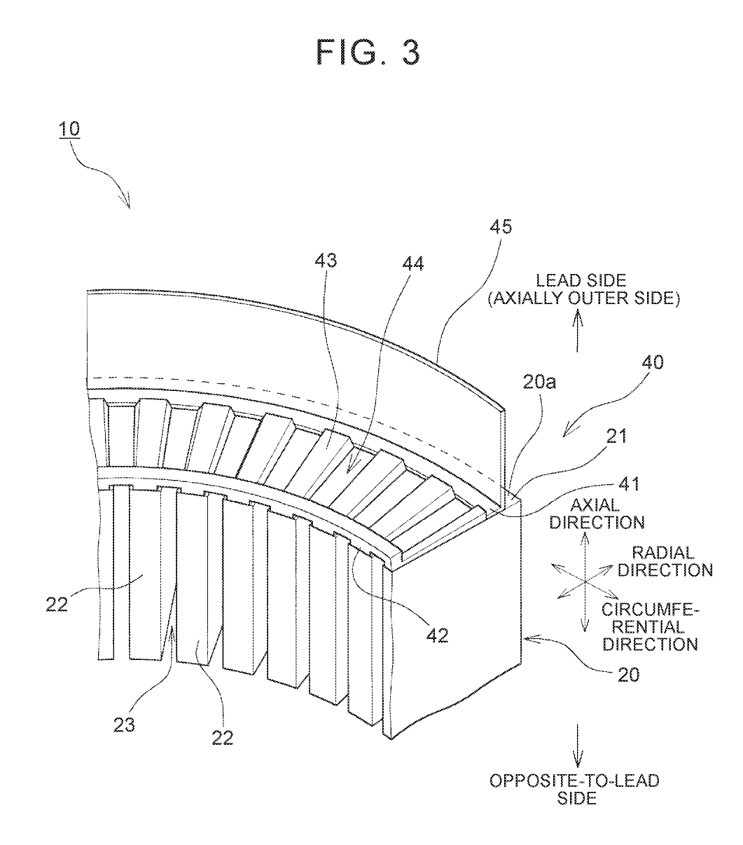

As illustrated in FIG. 2, the cuff support 40 is attached to the axial end surface 20a on the lead side of the stator core 20. The cuff support 40 is an insulating resin molding member, and is made of epoxy resin, for example. As illustrated in FIG. 3, the cuff support 40 includes an annular plate 41 having an annular shape and making contact with the yoke 21 of the axial end surface 20a on the lead side, ribs 43 projecting toward an inside-diameter direction from the annular plate 41 at respective positions corresponding to the teeth 22, and a ring 42 connecting inner peripheries of the ribs 43 to each other. A space between adjacent ribs 43 forms an opening 44 placed at a position corresponding to a space of the slot 23. Further, the cuff support 40 includes a cylindrical outer peripheral flange 45 extending axially outward on the lead side from an outer periphery of the annular plate 41. In other words, the cylindrical outer peripheral flange 45 extends in a direction opposite to a center of the stator core 20.

As illustrated in FIG. 2, the cuff support 40 descried above is attached in a reversed manner to the axial end surface 20b on the opposite-to-lead side of the stator core 20. The outer peripheral flange 45 of the cuff support 40 attached to the axial end surface 20b on the opposite-to-lead side extends axially outward on the opposite-to-lead side from the outer periphery of the annular plate 41.

The coil 30 is constituted by a plurality of conductor segments 31 inserted into all the slots 23 in the circumferential direction of the stator core 20. Note that FIG. 2 illustrates only a pair of conductor segments 31, but the conductor segments 31 are inserted into all the slots 23 of the stator core 20.

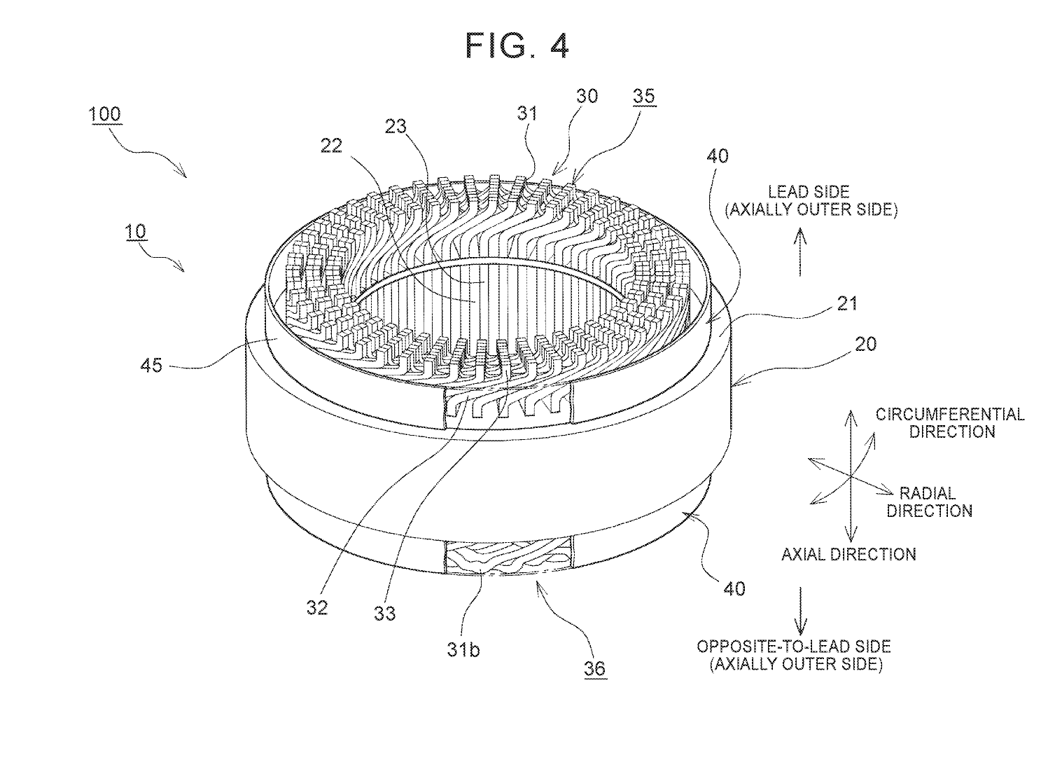

The conductor segment 31 has a U-shape, and includes two linear legs 31a, and a curved part 31b connecting them to each other. When the leg 31a of the conductor segment 31 is inserted into the opening 44 of the cuff support 40 on the opposite-to-lead side and the slot 23, the leg 31a projects axially outward from the opening 44 of the cuff support 40 on the lead side. A projecting part of the leg 31a from the opening 44 of the cuff support 40 is bent in the circumferential direction, and welded to a leg 31a of another conductor segment 31, as illustrated in FIG. 4. Thus, the conductor segments 31 pass through the slots 23 and the openings 44, so as to form the coil 30 wound around the teeth 22 and the rib 43. Bent parts 32 and welded parts 33 on the lead side form the coil end 35 on the lead side. In other words, the coil end 35 is adjacent to an axial end of the stator core 20. Further, the curved parts 31b of the conductor segments 31 project axially outward from the openings 44 of the cuff support 40 on the opposite-to-lead side. The curved parts 31b form the coil end 36 on the opposite-to-lead side. The coil end 35 on the lead side and the coil end 36 on the opposite-to-lead side have a generally annular outer shape.

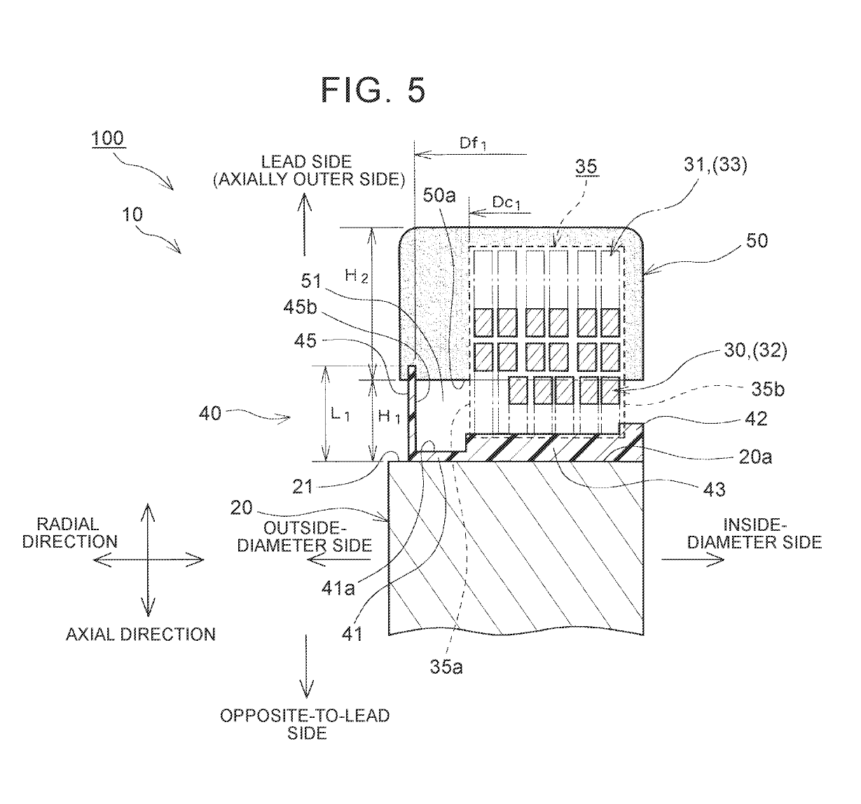

As illustrated in FIG. 5, an inside diameter Df1 of the outer peripheral flange 45 of the cuff support 40 is larger than an outside diameter Dc1 of the coil end 35. On this account, in a state where the stator core 20, the cuff support 40, and the conductor segments 31 are assembled as illustrated in FIG. 4, a gap ((Df1−Dc1)/2) is formed in the radial direction between an outer peripheral surface 35a of the coil end 35 and an inner peripheral surface 45b of the outer peripheral flange 45 of the cuff support 40. Further, a height of the outer peripheral flange 45 from the axial end surface 20a of the stator core 20 is L1, and the outer peripheral flange 45 projects axially outward relative to the bent parts 32 of the conductor segments 31.

In a state where the stator core 20, the cuff support 40, and the conductor segments 31 are assembled as illustrated in FIG. 4, a part where a height from the axial end surface 20a of the stator core 20 is from H1 to H2 is molded with the resin 50 as illustrated in FIG. 5. In other words, the cuff support 40 is placed between the stator core and the resin member. As illustrated in FIG. 5, since the height L1 of the outer peripheral flange 45 from the axial end surface 20a of the stator core 20 is higher than the height H1 of the molded resin 50 from the axial end surface 20a of the stator core 20, a distal end of the outer peripheral flange 45 between the height L1 and the height H1 is molded with the resin 50 together with the coil end 35. In the meantime, the resin 50 is not provided between the inner peripheral surface 45b of the outer peripheral flange 45 and the outer peripheral surface 35a of the coil end 35, between the height H1 and a coil-end-side surface 41a of the annular plate 41 of the cuff support 40. On this account, a surface 50a of the resin 50 on a stator-core-20 side, the inner peripheral surface 45b of the outer peripheral flange 45, the outer peripheral surface 35a of the coil end 35, and the coil-end-35-side surface 41a of the annular plate 41 of the cuff support 40 constitute an annular outer peripheral refrigerant chamber (first gap) 51.

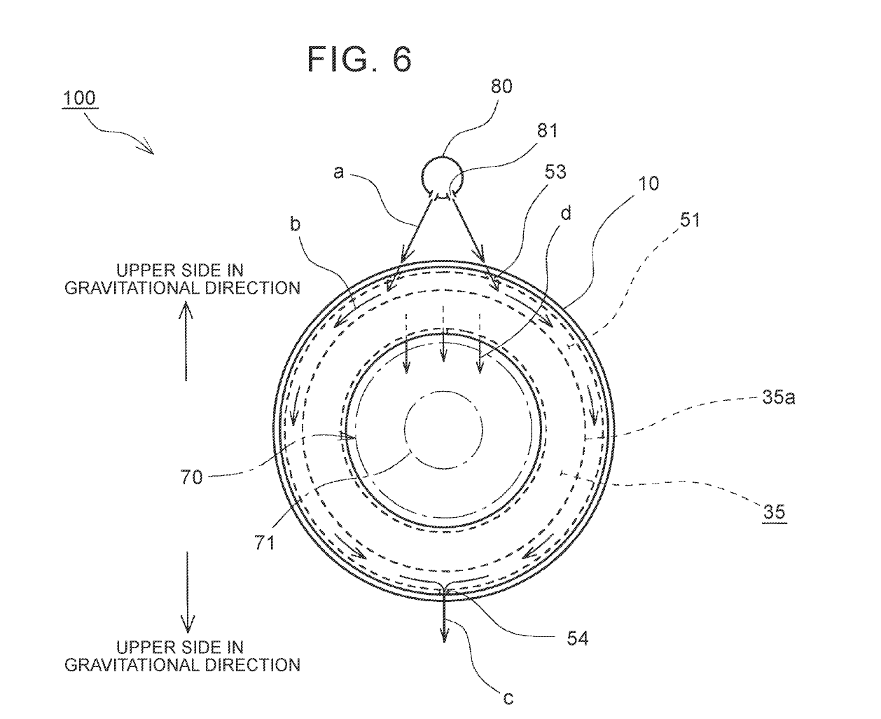

A rotor 70 having a rotating shaft 71 is incorporated on an inside-diameter side of the stator core 20 of the stator 10 described referring to FIG. 5 so as to form the rotary electric machine 100 as illustrated in FIG. 6, and the rotary electric machine 100 is provided in an electrically-driven vehicle or the like, for example, so that the rotating shaft 71 of the rotary electric machine 100 intersects with a gravitational direction. A refrigerant introduction hole (first hole) 53 through which a refrigerant is introduced into the outer peripheral refrigerant chamber 51 from outside is provided in the outer peripheral refrigerant chamber 51 on an upper side in the gravitational direction relative to the rotating shaft 71. Further, a refrigerant discharge hole (second hole) 54 through which the refrigerant is discharged from the outer peripheral refrigerant chamber 51 is provided in a bottom end of the outer peripheral refrigerant chamber 51 in the gravitational direction. The refrigerant introduction hole 53 is opened toward a diagonally upper direction along a direction (as indicated by an arrow a in FIG. 6) where the refrigerant is jetted from a nozzle 81 provided in a refrigerant supply pipe 80 placed on the upper side in the gravitational direction relative to the stator 10.

As illustrated in FIG. 6, the refrigerant jetted in the direction indicated by the arrow a from the nozzle 81 of the refrigerant supply pipe 80 flows into the outer peripheral refrigerant chamber 51 through the refrigerant introduction hole 53. The refrigerant flowing into the outer peripheral refrigerant chamber 51 is filled in the annular outer peripheral refrigerant chamber 51 and flows toward a lower side in the gravitational direction along the outer peripheral surface 35a of the coil end 35 as indicated by an arrow b of FIG. 6. At this time, the refrigerant cools the outer peripheral surface 35a of the coil end 35. The refrigerant that has cooled the coil end 35 flows toward the bottom end of the outer peripheral refrigerant chamber 51 in the gravitational direction and flows out from the refrigerant discharge hole 54 placed in the bottom end of the outer peripheral refrigerant chamber 51 in the gravitational direction, as indicated by an arrow c in FIG. 6. Further, a part of the refrigerant flowing into the annular outer peripheral refrigerant chamber 51 flows downward in the gravitational direction along the radial direction through gaps between the coil end 35 and the ribs 43 of the cuff support 40 as indicated by an arrow d of FIG. 6, so as to be applied to the rotor 70 from an axial gap between the resin 50 and the ring 42 of the inner peripheral side of the cuff support 40.

As such, the rotary electric machine 100 in the present embodiment is configured such that the outer peripheral flange 45 of the cuff support 40 and the coil end 35 are integrally molded with the resin 50, and the annular outer peripheral refrigerant chamber 51 is constituted by the resin 50, the inner peripheral surface 45b of the outer peripheral flange 45, the outer peripheral surface 35a of the coil end 35, and the coil-end-35-side surface 41a of the annular plate 41 of the cuff support 40. Hereby, the outer peripheral refrigerant chamber 51 through which the refrigerant flows along the outer peripheral surface 35a of the coil end 35 can be formed without attaching a cover as an extra component to the coil end like the rotary electric machine in the related art described in JP 2010-124658 A. Further, since it is not necessary to attach the cover to the outer side of the coil end 35, the stator 10 can be downsized.

Even in a case where a flow rate of the refrigerant is small, the outer peripheral refrigerant chamber 51 allows the refrigerant to make contact with the coil end 35, which makes it possible to efficiently cool the coil end 35. As such, the rotary electric machine 100 of the present embodiment can efficiently cool the stator 10 with a simple configuration and downsize the stator 10.

The embodiment described above deals with a case where the coil end 35 on the lead side and the cuff support 40 are integrally molded with the resin 50 so as to form the outer peripheral refrigerant chamber 51. However, similarly, the coil end 36 on the opposite-to-lead side and the cuff support 40 are integrally molded with the resin 60 so as to form an outer peripheral refrigerant chamber.

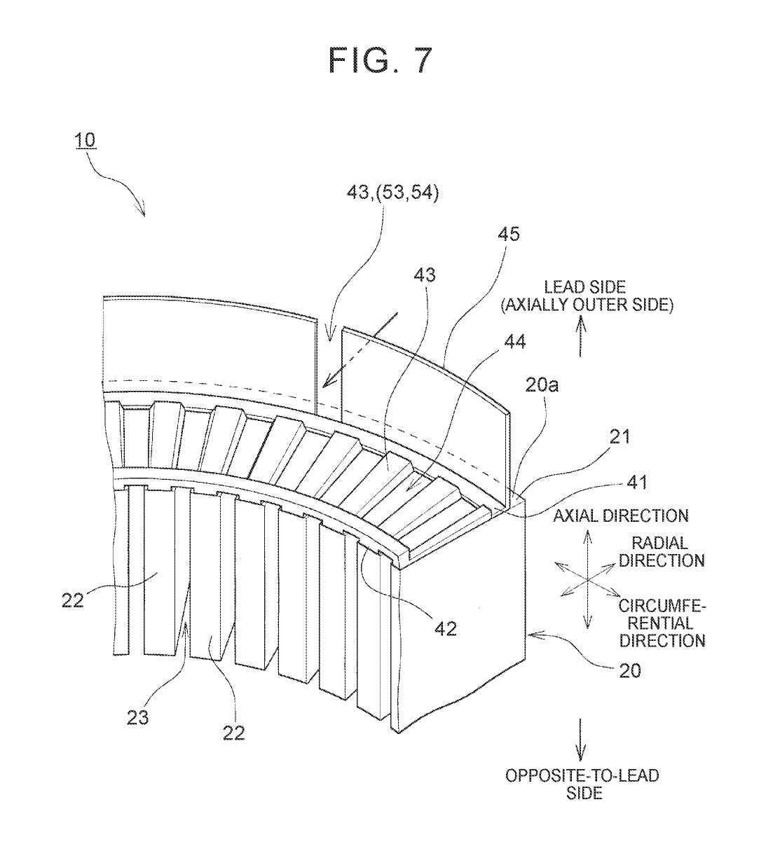

Note that the refrigerant introduction hole 53 and the refrigerant discharge hole 54 may be machined after molding with the resins 50, 60 are performed, or as illustrated in FIG. 7, a hold may be formed in the outer peripheral flange 45 such that a slit 47 is provided in the outer peripheral flange 45 of the cuff support 40, and the cuff support 40 and the coil end 35, 36 are integrally molded with the resin 50, 60.

With reference to FIGS. 7 to 11, the following describes another embodiment of the present disclosure. A part similar to a part described with reference to FIGS. 1 to 7 has a similar reference sign, and a description thereof is omitted.

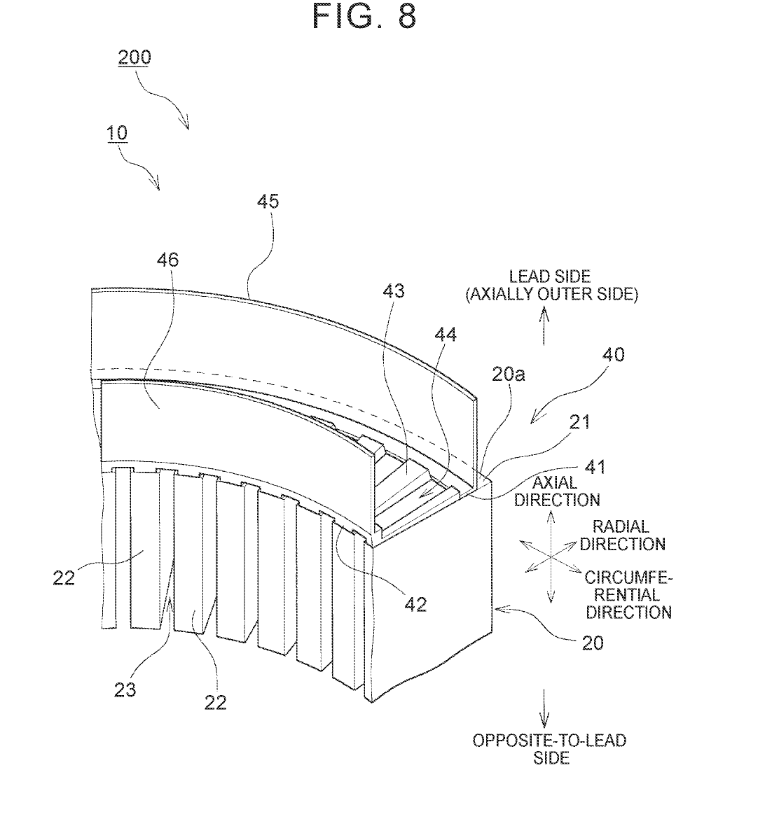

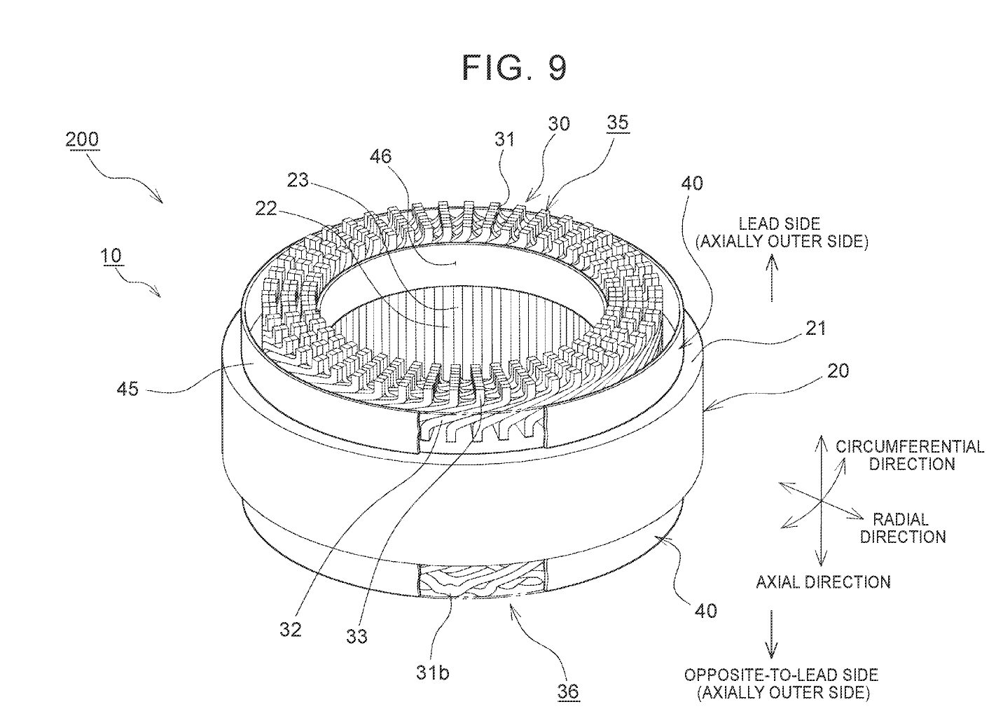

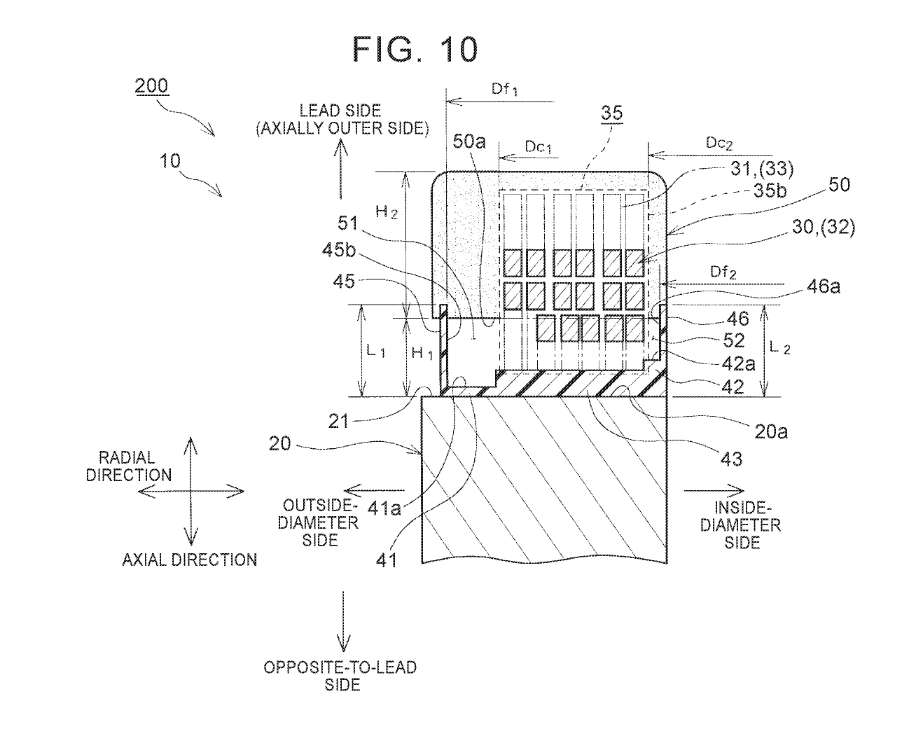

As illustrated in FIG. 8, a rotary electric machine 200 of the present embodiment is configured as follows. That is, an inner peripheral flange 46 is provided in the cuff support 40 provided in the rotary electric machine 100 of the embodiment described with reference to FIGS. 1 to 7 and the cuff support 40 and conductor segments 31 are assembled to a stator core 20 as illustrated in FIG. 9. After that, the inner peripheral flange 46 and a coil end 35 are integrally molded with a resin 50 as illustrated in FIG. 10, so that an annular inner peripheral refrigerant chamber (second gap) 52 is constituted by the resin 50, an outer peripheral surface 46a of the inner peripheral flange 46, an inner peripheral surface 35b of the coil end 35, and a coil-end-35-side surface 42a of a ring 42 of the cuff support 40.

As illustrated in FIG. 10, an inside diameter Df2 of the inner peripheral flange 46 of the cuff support 40 is smaller than an inside diameter Dc2 of the coil end 35. On this account, in a state where the stator core 20, the cuff support 40, and the conductor segments 31 are assembled as illustrated in FIG. 9, a gap ((Dc2−Df2)/2) is formed in the radial direction between the inner peripheral surface 35b of the coil end 35 and the outer peripheral surface 46a of the inner peripheral flange 46 of the cuff support 40. Further, a height of the inner peripheral flange 46 from the axial end surface 20a of the stator core 20 is L2, and the inner peripheral flange 46 projects axially outward relative to bent parts 32 of the conductor segments 31.

In a state where the stator core 20, the cuff support 40, and the conductor segments 31 are assembled as illustrated in FIG. 9, a part where a height from the axial end surface 20a of the stator core 20 is from H1 to H2 is molded with the resin 50 as illustrated in FIG. 10. As illustrated in FIG. 10, since the height L1 of the inner peripheral flange 46 from the axial end surface 20a of the stator core 20 is higher than the height H1 of the molded resin 50 from the axial end surface 20a of the stator core 20, a distal end of the inner peripheral flange 46 between the height L1 and the height H1 is molded with the resin 50 together with the coil end 35. In the meantime, the resin 50 is not provided between the outer peripheral surface 46a of the inner peripheral flange 46 and the inner peripheral surface 35b of the coil end 35, between the height H1 and a coil-end-side surface 42a of the ring 42 of the cuff support 40. Hereby, an annular inner peripheral refrigerant chamber 52 is constituted by a stator-core-20-side surface 50a of the resin 50, the outer peripheral surface 46a of the inner peripheral flange 46, the inner peripheral surface 35b of the coil end 35, and the coil-end-35-side surface 42a of the ring 42 of the cuff support 40.

The embodiment described above deals with a case where the coil end 35 on the lead side and the cuff support 40 are integrally molded with the resin 50 so as to form the inner peripheral refrigerant chamber 52, but similarly, the coil end 36 on the opposite-to-lead side and the cuff support 40 are integrally molded with the resin 60 so as to form an inner peripheral refrigerant chamber.

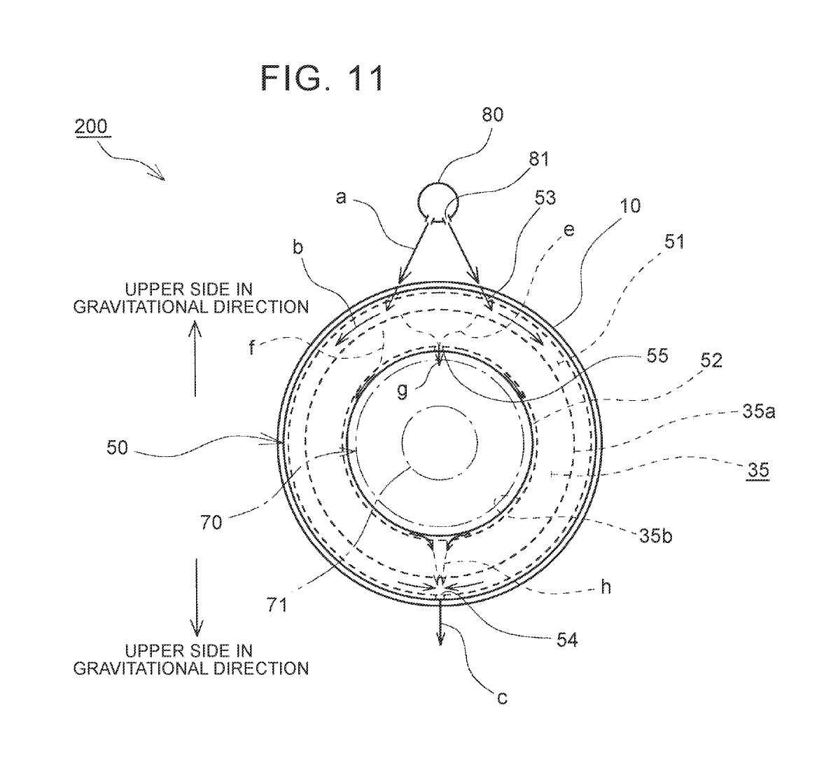

As illustrated in FIG. 11, in the rotary electric machine 200, a rotor refrigerant supply hole (third hole) 55 through which a refrigerant is applied to a rotor 70 from the inner peripheral refrigerant chamber 52 is provided in the inner peripheral refrigerant chamber 52 on the upper side in the gravitational direction relative to a rotating shaft 71.

Similarly to the rotary electric machine 100 described earlier, the refrigerant jetted in a direction indicated by an arrow a from a nozzle 81 of a refrigerant supply pipe 80 flows into an outer peripheral refrigerant chamber 51 through a refrigerant introduction hole 53, as illustrated in FIG. 11. The refrigerant flowing into the outer peripheral refrigerant chamber 51 is filled in the annular outer peripheral refrigerant chamber 51 and flows toward the lower side in the gravitational direction along an outer peripheral surface 35a of the coil end 35 as indicated by an arrow b of FIG. 11. At this time, the refrigerant cools the outer peripheral surface 35a of the coil end 35. The refrigerant that has cooled the coil end 35 flows toward a bottom end of the outer peripheral refrigerant chamber 51 in the gravitational direction and flows out from a refrigerant discharge hole 54 placed in the bottom end of the outer peripheral refrigerant chamber 51 in the gravitational direction, as indicated by an arrow c in FIG. 11.

Further, a part of the refrigerant flowing into the annular outer peripheral refrigerant chamber 51 flows downward in the gravitational direction along the radial direction through gaps between the coil end 35 and ribs 43 of the cuff support 40 as indicated by arrows e, f in FIG. 11, and flows into the inner peripheral refrigerant chamber 52. The refrigerant flowing into the inner peripheral refrigerant chamber 52 is filled in the inner peripheral refrigerant chamber 52 and flows downward in the gravitational direction along the inner peripheral surface 35b of the coil end 35. At this time, the refrigerant cools the inner peripheral surface 35b of the coil end 35. Then, as indicated by arrows h, c in FIG. 11, the refrigerant flows toward the outer peripheral refrigerant chamber 51 from the inner peripheral refrigerant chamber 52 through the gaps between the coil end 35 and the ribs 43 of the cuff support 40, and then flows out from the refrigerant discharge hole 54 placed in the bottom end of the outer peripheral refrigerant chamber 51 in the gravitational direction. Further, a part of the refrigerant thus flowing into the inner peripheral refrigerant chamber 52 from the annular outer peripheral refrigerant chamber 51 is applied to an outer surface of the rotor 70 through a rotor refrigerant supply hole 55, so as to cool the rotor 70

As such, the rotary electric machine 200 of the present embodiment is configured such that the inner peripheral flange 46 of the cuff support 40 and the coil end 35 are integrally molded with the resin 50, and the annular inner peripheral refrigerant chamber 52 is constituted by the resin 50, the outer peripheral surface 46a of the inner peripheral flange 46, the inner peripheral surface 35b of the coil end 35, and the coil-end-35-side surface 42a of the ring 42 of the cuff support 40. Hereby, the inner peripheral refrigerant chamber 52 through which the refrigerant flows along the inner peripheral surface 35b of the coil end 35 can be formed without attaching a cover as an extra component to the coil end like the rotary electric machine in the related art described in JP 2010-124658 A, which makes it possible to downsize the stator 10.

Further, since the refrigerant can be brought into contact with the outer peripheral surface 35a and the inner peripheral surface 35b of the coil end 35, even in a case where a flow rate of the refrigerant is small, the coil end 35 can be cooled more efficiently. Further, since the refrigerant can be applied to the rotor 70 from the inner peripheral refrigerant chamber 52, the rotor 70 can be also cooled as well as the stator 10.

What is claimed is:

1. A rotary electric machine comprising:
a stator core including
an annular yoke,
a plurality of teeth projecting toward an inner peripheral side of the yoke, the teeth defining a plurality of slots between the teeth;
a resin member;
an annular cuff support having a plurality of ribs corresponding to the teeth and a plurality of openings corresponding to the slots, the cuff support being placed between the stator core and the resin member; and
a coil passing through the slots and the openings, the coil including an annular coil end that is adjacent to an axial end of the stator core, and the coil wound around the teeth and the ribs, wherein
the cuff support includes a cylindrical outer-peripheral flange having an inside diameter larger than an outside diameter of the coil end and extending in a direction opposite to a center of an axial direction of the stator core,
the outer-peripheral flange is provided such that the outer-peripheral flange is apart from the coil end, and the outer-peripheral flange is opposed to the coil end,
the resin member is provided such that the resin member is apart from the cuff support, and the resin member covers a part of the outer-peripheral flange and the coil end, and
the outer-peripheral flange, the coil end, the resin member, and the cuff support define a first gap among the outer-peripheral flange, the coil end, the resin member, and the cuff support.

2. The rotary electric machine according to claim 1, wherein
when a rotating shaft of the rotary electric machine is placed with a posture intersecting with a gravitational direction, the flange has a first hole through which a refrigerant is introduced into the first gap and a second hole through which the refrigerant is discharged from the first gap,
the first hole is placed on an upper side in the gravitational direction relative to the rotating shaft, and
the second hole is placed on a bottom end of the flange in the gravitational direction.

3. The rotary electric machine according to claim 1, wherein:
the cuff support includes a cylindrical inner-peripheral flange having an outside diameter smaller than an inside diameter of the coil end and extending in a direction opposite to the center of the stator core;
the inner-peripheral flange is provided such that the inner-peripheral flange is apart from the coil end, and the inner-peripheral flange is opposed to the coil end;
the resin member is provided such that the resin member is apart from the cuff support, and the resin member covers the inner-peripheral flange and the coil end; and
the resin member, the inner peripheral flange, the coil end, and the cuff support define a second gap among the resin member, the inner peripheral flange, the coil end, and the cuff support.

4. The rotary electric machine according to claim 3, wherein
when a rotating shaft of the rotary electric machine is placed with a posture intersecting with a gravitational direction, the cuff support has a third hole through a refrigerant is discharged from the second gap toward a rotor, and the third hole is placed on an upper side in the gravitational direction relative to the rotating shaft.
